(19) United States
(12) Patent Application Publication
(10) Pub. No.: US 2009/0088026 A1
(43) Pub. Date: Apr. 2, 2009

(54) FUSE PULLER AND ELECTRIC JUNCTION BOX

(75) Inventors: Hiroyasu FURUYA, Kakegawa-shi (JP); Tatsuya INABA, Kakegawa-shi (JP); Masahiro KAWAZU, Kakegawa-shi (JP); Junpei KITAGAWA, Kakegawa-shi (JP); Toshihisa YAGI, Kakegawa-shi (JP); Norihiro OBAMA, Wako-shi (JP)

Correspondence Address: SUGHRUE-265550, 2100 PENNSYLVANIA AVE. NW, WASHINGTON, DC, 20037-3213, US

(73) Assignees: YAZAKI CORPORATION, Tokyo (JP); HONDA MOTOR CO., LTD., Tokyo (JP)

(21) Appl. No.: 12/237,647

(22) Filed: Sep. 25, 2008

(30) Foreign Application Priority Data
Sep. 28, 2007 (JP) 2007-256663

(51) Int. Cl. H01R 13/68; B25B 27/14

(52) U.S. Cl. 439/620.27; 81/3.8

(57) ABSTRACT

A fuse puller includes a body, and a first fuse that is permanently engaged with the body in fixed relation thereto. A electric junction box includes the fuse puller and a fuse mounting surface to which a plurality of fuses including the first fuse are mounted so as to be arranged in parallel to each other.

### BACKGROUND

This invention relates to an improved fuse puller and an improved electric junction box (i.e., an electric junction block).

At a place where vehicles such as automobiles are produced, an inspection such as electrical connection testing for on-board equipments mounted on the vehicle is carried out, and thereafter only those vehicles which have passed this inspection are delivered to dealers. Generally, a vehicle is equipped with on-board equipments (hereinafter referred to as “normally-energized equipments”), such as a clock, a room lamp, etc., which are always supplied with electric power from a battery regardless of the position of an ignition key. Therefore, when the vehicle is stored for a long time after the above inspection, a dark current continues to flow through the above normally-energized equipments for a long time, and there is a possibility that a battery serving as a power source may be exhausted or dead before the vehicle is delivered to a dealer.

To overcome this problem, there has been adopted a method in which a dark current fuse is provided in an electric wire electrically connecting the power source to the normally-energized equipments, and after the inspection is carried out, an inspector removes the dark current fuse, and thereafter at the time when maintenance of the vehicle is effected by the dealer so that the vehicle can be delivered to the user, a maintenance man or the like of the dealer again attaches a fuse to an electric junction box such as a fuse box.

However, generally, the electric junction box such as the fuse box to which the above dark current fuse is attached is mounted at a lower portion of an instrument panel within a car compartment, and therefore it is not easy for an inspector to remove the dark current fuse from the electric junction box in an inspection line. Therefore, there has been proposed a technique in which instead of removing the dark current fuse, the dark current fuse is melted after the inspection is finished (see, for example, Patent Literature 1). In this proposed technique, a coupler for melting purposes is attached to a connector of a wire harness extending from the electric junction box, thereby melting the dark current fuse.

However, even when this technique is adopted, it is necessary for the dealer to remove the melted dark current fuse (i.e., the old fuse) and then to insert a new fuse for exchange purposes. More specifically, the old fuse mounted in a first receiving portion of the electric junction box is gripped by a fuse puller and is pulled therefrom by this fuse puller, and then is discarded. Thereafter, the new fuse mounted in a second receiving portion is gripped by the fuse puller, and is removed therefrom by the above fuse puller, and is inserted into the first receiving portion. Thus, the maintenance man or the like of the dealer is required to effect a series of steps of such cumbersome fuse exchange operation. The fuse puller is held as standard equipment in a fuse puller holding portion (which is provided merely for the purpose of holding the fuse puller) within the electric junction box.

[Patent Literature 1] JP-A-2006-304434

In the electric junction box having the melted dark current fuse mounted therein, many other fuses than the dark current fuse which have the same outer shape as the dark current fuse are arranged together with the dark current fuse in a juxtaposed manner. Namely, a fuse mounting surface of the electric junction box is such that it is difficult to identify, from the appearance, the melted dark current fuse among the plurality of juxtaposed fuses.

Here, even if the position of the melted dark current fuse in the electric junction box is predetermined, there is not provided the situation in which anyone such as the maintenance man of the dealer can find and remove the melted dark current fuse soon after start of the fuse exchange operation regardless of his skill in carrying out this fuse exchange operation. Therefore, much time was required for the fuse exchange operation. And besides, there is a possibility that the maintenance man or the like of the dealer may mistake some other fuse for the melted dark current fuse, and in such a case the fuse exchange operation must be carried out again.

When there is provided a parallel receiving portion electrically connected in parallel with the first receiving portion as in the technique of Patent Literature 1, it is only necessary to mount the new fuse in the parallel receiving portion, and the melted dark current fuse does not need to be removed from the first receiving portion. However, when the melted dark current fuse remains in the electric junction box, it is feared that the user of the vehicle may feel uneasy, and therefore it is preferred to remove this dark current fuse from the electric junction box.

Thus, although the melted dark current fuse or other fuse should be removed from the electric junction box, it has been difficult to easily find the relevant fuse and to remove it.

### SUMMARY

This invention has been made in view of the above circumstances, and an object of the invention is to provide a fuse puller and an electric junction box, in which a fuse exchange operation can be carried out easily and positively.

The above object has been achieved by a fuse puller of the present invention having features recited in the following Paragraphs (1) to (3).

(1) A fuse puller comprises:

a body; and

a first fuse that is permanently engaged with the body in fixed relation thereto.

(2) In the fuse puller of the above Paragraph (1), the first fuse has a fusible element which is melted.

(3) In the fuse puller of the above Paragraph (1) or Paragraph (2), the body includes a permanent engagement portion which is permanently engaged with the first fuse, and a holding portion which holds a second fuse against an electric junction box. The second fuse is received in the electric junction box in adjoining relation to the first fuse received in the electric junction box.

In the fuse puller of the above Paragraph (1), the body of the fuse puller is conspicuous at the fuse mounting surface at which the plurality of fuses including the first fuse are arranged in a juxtaposed manner, and therefore the first fuse which is to be removed can be easily found out among the plurality of fuses, and therefore a fuse exchange operation can be carried out easily and positively. Here, the first fuse may or may not be in a melted condition.

In the fuse puller of the above Paragraph (2), an operation for exchanging the melted first fuse can be carried out easily and positively.

In the fuse puller of the above Paragraph (3), even when the second fuse is loosely fitted in the electric junction box, the second fuse can be positively retained in the electric junction box.

The above object has also been achieved by an electric junction box having features recited in the following Paragraphs (4) to (8).

(4) A electric junction box comprises:

a fuse puller that includes a body and a first fuse which is engaged with the body; and

a fuse mounting surface to which a plurality of fuses including the first fuse are mounted so as to be arranged in parallel to each other.

(5) In the electric junction box of the above Paragraph (4), the first fuse is permanently engaged with the body in fixed relation thereto.

(6) In the electric junction box of the above Paragraph (4) and Paragraph (5), the first fuse has a fusible element which is melted.

(7) In the electric junction box of any one of the above Paragraphs (4) to (6), the body includes an engagement portion which is engaged with the first fuse, and a holding portion which holds a second fuse loosely fitted in a second receiving portion disposed adjacent to the first fuse held in a first receiving portion of the fuse mounting surface.

(8) In the electric junction box of any one of the above Paragraphs (4) to (7), the plurality of fuses including the first fuse have the same outer shape.

In the electric junction box of the above Paragraph (4), the body of the fuse puller is conspicuous at the fuse mounting surface at which the plurality of fuses including the first fuse are arranged in a juxtaposed manner, and therefore the first fuse which is to be removed can be easily found out among the plurality of fuses, and therefore the fuse exchange operation can be carried out easily and positively. Here, the first fuse may or may not be in a melted condition.

In the electric junction box of the above Paragraph (5), the first fuse will not be disengaged from the body of the fuse puller, and this is desirable.

In the electric junction box of the above Paragraph (6), the operation for exchanging the melted first fuse can be carried out easily and positively. In addition, the melted first fuse is permanently engaged with the body of the fuse puller in fixed relation thereto, and this eliminates a possibility that the melted first fuse is disengaged from the electric junction box, and is reused by mistake.

In the electric junction box of the above Paragraph (7), even when the second fuse is loosely fitted in the electric junction box, the second fuse can be positively retained in the electric junction box. In this case, when the first fuse is in a melted condition, and the second fuse is an exchange fuse for exchange with this melted first fuse, then the fuse exchange operation can be carried out smoothly.

In the electric junction box of the above Paragraph (8), the first fuse which is to be removed can be easily found out among the plurality of fuses having the same outer shape, and therefore the fuse exchange operation can be carried out easily and positively.

In the present invention, the fuse (that is, the fuse engaged with the body of the fuse puller) which is to be removed can be easily found out among the plurality of fuses arranged in a juxtaposed manner in the electric junction box, and therefore the fuse exchange operation can be carried out easily and positively. Therefore, in the present invention, the time and labor required for the fuse exchange operation can be reduced.

The present invention has been briefly described above. Details of the invention will become more manifest upon reading the following Section “Best Mode for Carrying Out the Invention” with reference to the accompanying drawings.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a circuit diagram of one preferred embodiment of a fuse box (electric junction box) of the present invention;

FIG. 2 is a perspective view of one of a plurality of fuses to be mounted in the fuse box of FIG. 1;

FIG. 3 is a plan view of the fuse box of FIG. 1;

FIG. 4A is a perspective view of an important portion of the fuse box of FIG. 3 in which a fuse puller of the invention incorporating the fuse of FIG. 2 is mounted, and FIG. 4B is a perspective view showing the fuse puller alone;

FIG. 5 is an enlarged perspective view of the fuse puller of FIG. 4B with which the fuse is not yet permanently engaged in fixed relation thereto;

FIG. 6 is a cross-sectional view taken along the line VI-VI of FIG. 4A;

FIG. 7 is a view showing a fuse exchange method in which the fuse puller is pulled out of the fuse box of FIG. 6;

FIG. 8A is a perspective view of an important portion of a fuse box in which a modified fuse puller of the invention is mounted, and FIG. 8B is a perspective view showing the modified fuse puller of FIG. 8A and a second fuse held by a holding portion of the fuse puller against withdrawal from a second receiving portion;

FIG. 9 is a cross-sectional view taken along the line IX-IX of FIG. 8A; and

FIG. 10 is a view showing a fuse exchange method in which the modified fuse puller is pulled out of the fuse box 2A of FIG. 9.

### DETAILED DESCRIPTION OF EXEMPLARY EMBODIMENTS

A preferred embodiment of the present invention will now be described with reference to the drawings.

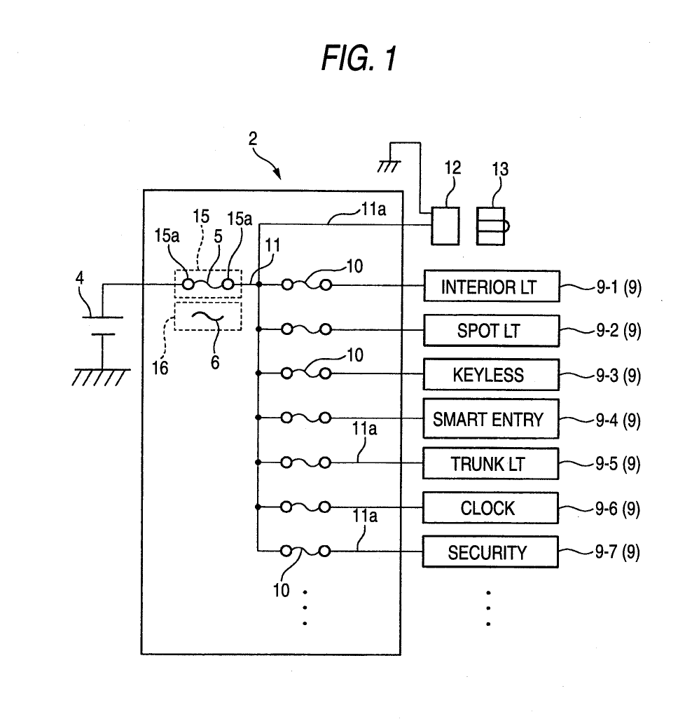

FIG. 1 is a circuit diagram of one preferred embodiment of a fuse box (electric junction box) of the invention. A wire 11 extending from a battery 4 serving as a power source of a vehicle branches into a plurality of wires 11a, and is connected to various on-board equipments (normally-energized equipments 9 (9-1, 9-2, 9-3, 9-4, 9-5, 9-6 and 9-7). Fuses 10 are provided at the branch wires 11a so as to prevent an excess current from flowing through the on-board equipments 9. A first fuse 5 is provided at that portion of the wire 11 disposed upstream of the branch wires 11a, and is adapted to be forcibly melted so as to prevent a dark current from flowing through the on-board equipments 9.

The first fuse 5, together with the plurality of fuses 10, is mounted in a fuse box 2. The first fuse 5 is a fuse which forms part of one preferred embodiment of a fuse puller of the invention and is detachably received in a first receiving portion 15 of the fuse box 2. Connection terminals 15a and 15a for electrically connecting the first fuse 5 to the wire 11 are provided in the first receiving portion 15. A second fuse 6 is detachably received in a second receiving portion 16 disposed adjacent to the first receiving portion 15. This second fuse 6 is not electrically connected to the wire 11.

On the other hand, the wire 11 is branched downstream of the first receiving portion 15, and this branch wire is led out to the exterior of the fuse box 2, and is electrically connected to a connector 12. When a coupler 13 is connected to this connector 12, the wire 11 downstream of the first receiving portion 15 is grounded (that is, connected to the ground). As a result, an excess current flows through the wire 11, so that the first fuse 5 is melted.

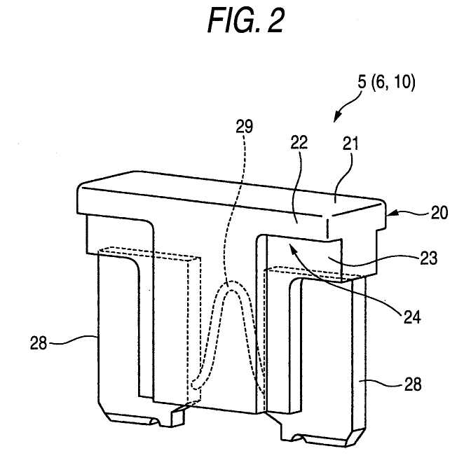

FIG. 2 is a perspective view of each of the plurality of the fuses 5, 6 and 10 mounted in the fuse box of FIG. 1. The first fuse 5, the second fuse 6 and the fuses 10 have the same construction (however, all of these fuses do not always have the same rated current value), and have the same outer shape (or appearance). Each of the fuses 5, 6 and 10 is a so-called blade-type fuse, and comprises a cover member 20 having a generally T-shape when viewed from the front-side thereof, and a pair of parallel plate-like terminals 28 and 28 projecting downwardly respectively from opposite side portions of the cover member 20. A fusible element 29 extends between and is formed integrally with the pair of plate-like terminals 28 and 28. The cover member 20 of a hollow construction covers the fusible element 29.

The cover member 20 is made of a colored transparent insulative synthetic resin or the like. Since the cover member 20 is made of the transparent material, whether the fusible element 29 is melted or not can be confirmed with the eyes from a side face thereof, but can hardly be confirmed from a top surface 21 thereof. The cover member 20 includes a wide portion 22 of a generally T-shaped cross-section, and narrow portions 23 formed respectively at opposite side portions of the wide portion 22. Engagement portions 24 are formed at the opposite side portions of the wide portion 22, each engagement portion 24 being formed at the step between the wide portion 22 and the narrow portion 23.

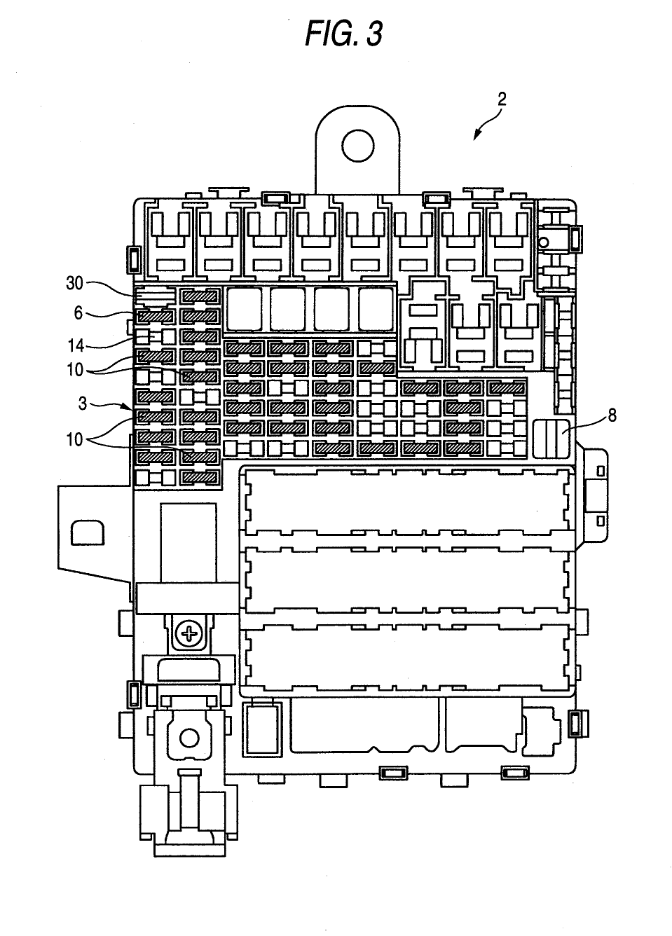

FIG. 3 is a plan view of the fuse box 2 of FIG. 1. At a fuse mounting surface 3 of the fuse box 2 of FIG. 3, the first fuse 5 (located at a position such that it can not be viewed in FIG. 3), the second fuse 6 and the plurality of fuses 10 are detachably received respectively in a plurality of receiving portions 14 including the first receiving portion 15 and the second receiving portion 16, and are juxtaposed such that their top surfaces 21 are disposed flush with one another. The fuse puller 30 including as a constituent element the first fuse 5 permanently engaged therewith in fixed relation thereto is provided at the fuse mounting surface 3 of the fuse box 2.

Also, a general purpose fuse puller 8 is provided at the fuse box 2. The general purpose fuse puller 8 is a fuse exchange tool for attaching and detaching each of the second fuse 6 and the fuses 10 relative to the fuse box 2, and is formed into a clothespin-like shape so as to grip each fuse 6, 10.

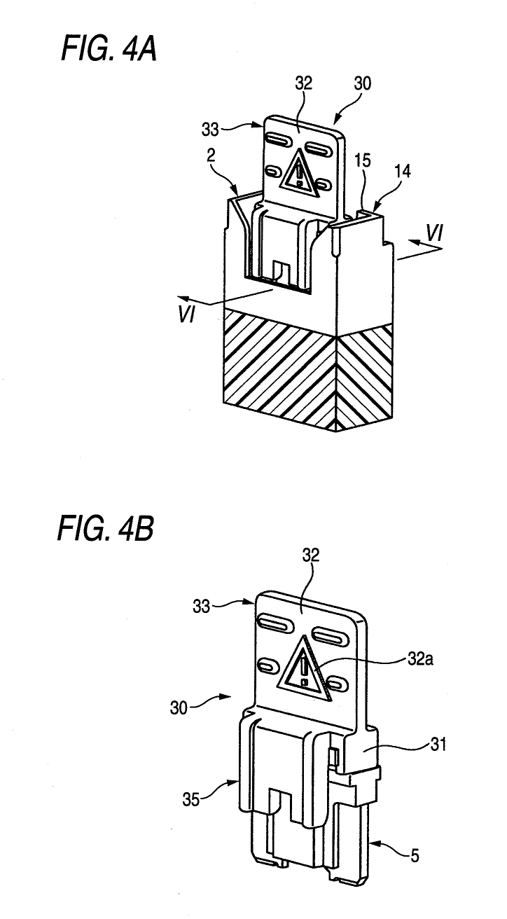

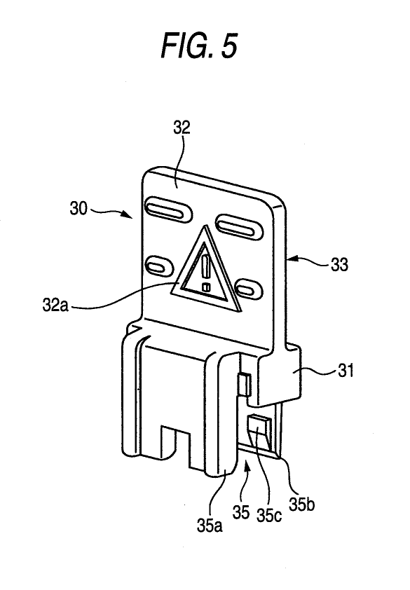

FIG. 4A is a perspective view of an important portion of the fuse box 2 of FIG. 3 having the fuse puller 30 attached thereto, and FIG. 4B is a perspective view showing the fuse puller 30 alone. FIG. 5 is an enlarged perspective view showing the fuse puller 30 (that is, a body 33 of this fuse puller 30 alone) with which the first fuse 5 is not yet permanently engaged in fixed relation thereto.

The fuse puller 30 except the first fuse 5, that is, its body 33, is made of an insulative synthetic resin, and has a base portion 31 at a generally central portion of the body 33. A plate-like grip portion 32 is integrally formed (molded) on and projects from a widthwise-central portion of an upper surface of the base portion 31. The grip portion 32 has opposite side faces which are so wide as to be gripped by the fingers, and an index 32a (such as a mark) serving also as a non-slip portion is formed by embossing or engraving on at least one of these opposite side faces. A permanent engagement portion 35 for permanent engagement with the first fuse 5 in fixed relation thereto is formed (molded) integrally on the base portion 31.

More specifically, the permanent engagement portion 35 includes a pair of side walls 35a and 35b formed respectively at opposite side edges of the base portion 31, and extend downwardly from a lower surface of the base portion 31. Retaining claws 35c of a rectangular parallelepiped shape are formed on and project from an inner surface of each side wall 35a, 35b. The engagement portions 24 of the first fuse 5 are permanently engaged with the upper sides of the retaining claws 35c, so that the permanent engagement portion 35 and the first fuse 5 are permanently fixed to each other. A lower surface of each retaining claw 35c is tapering so as to guide the engagement portion 24 of the first fuse 5 to the upper side of the retaining claw 35c.

Next, inspection of the on-board equipments, transport of the vehicle, and a method of exchanging the fuse will be briefly described with reference to FIGS. 1 and 3.

First, in an inspection line at a vehicle production site of a vehicle manufacturer, the on-board equipments 9 are energized via the first fuse 5, and at this time the inspection of the on-board equipments 9 is effected. After this inspection is finished, the coupler 13 is connected to the connector 12, thereby melting the first fuse 5. Whether the inspection of the on-board equipments 9 is effected via the first fuse 5 alone or via the fuse puller 30 incorporating the first fuse 5 is suitably selected, and in any case the first fuse 5 is permanently fixed to the permanent engagement portion 35 of the fuse puller 30 before the vehicle subjected to the inspection is delivered (shipped) from the vehicle manufacturer. However, preferably, all of the plug-in electrical parts including the fuses 5, 6 and 10 are mounted on the fuse box 2, and then the body 33 of the fuse puller 30 is attached to the first fuse 5, and thereafter the fuse box 2 is mounted at a lower portion of an instrument panel within a vehicle compartment, and then the first fuse 5 permanently engaged with the body 33 of the fuse puller 30 is melted. With this mounting method, the inspector is not required to attach the fuse puller 30 to the first fuse 5 mounted in the fuse box 2 mounted at the lower portion of the instrument panel, and advantageously the body 33 of the fuse puller 30 can be attached to the first fuse 5 (mounted in the fuse box 2 not yet mounted at the lower portion of the instrument panel), using a machine (which can be used since the lower surface of each retaining claw 35c is tapering), and this is preferred.

Then, the vehicle in this condition is transported from the vehicle manufacturer to a dealer. Therefore, a dark current is prevented from flowing through the on-board equipments 9.

Then, the melted first fuse 5 received in the first receiving portion 15 of the fuse box 2 is exchanged with the second fuse 6 (which is not melted) by the dealer.

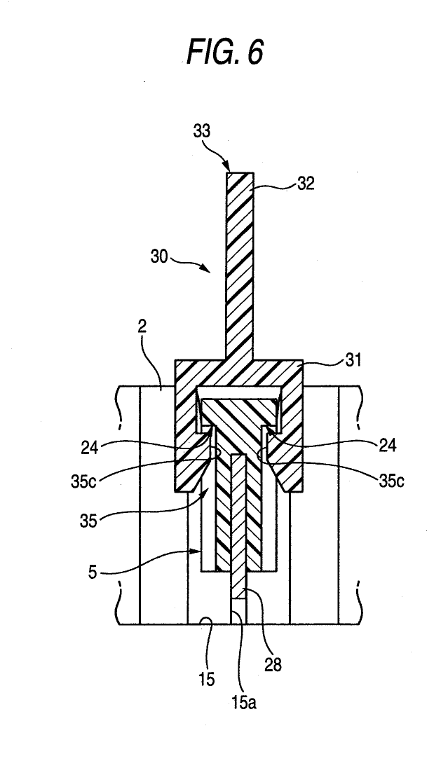

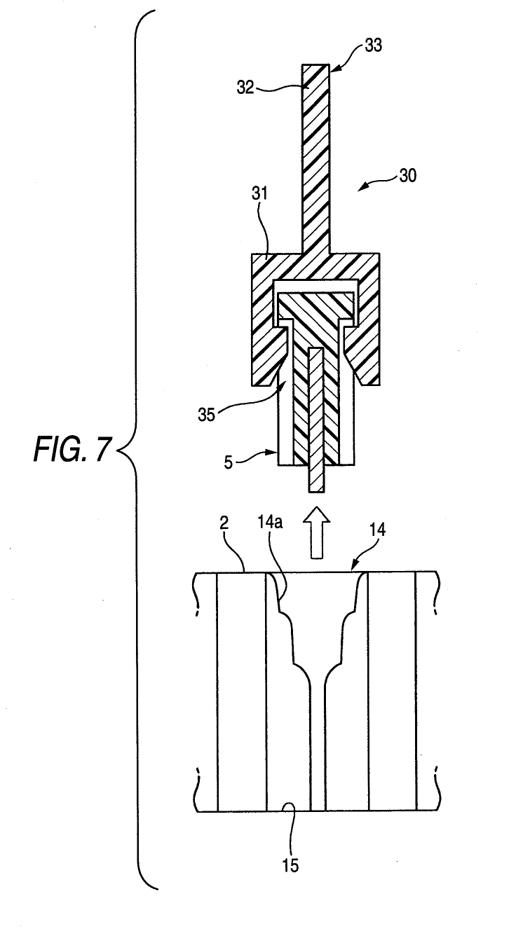

The method of exchanging the fuse will be described in further detail with reference to FIGS. 6 and 7. FIGS. 6 and 7 are views explanatory of the fuse exchange method, and FIG. 6 is a cross-sectional view taken along the line VI-VI of FIG. 4A, and FIG. 7 is the view showing the fuse exchange method in which the fuse puller 30 is pulled out of the fuse box 2 of FIG. 6.

As shown in FIG. 6, the first fuse 5 of the fuse puller 30 is received in the first receiving portion 15 of the fuse box 2. A groove-like stepped portion 14a (see FIG. 7) for holding the wide portion 22 (see FIG. 2) of the cover member 20 is formed in each of the receiving portions 14 including the first receiving portion 15, and thanks to the provision of the groove-like stepped portion 14a, the first fuse 5 is detachably held in the receiving portion 14. Furthermore, the plate-like terminals 28 of the first fuse 5 are gripped respectively by the connection terminals 15a in the first receiving portion 15, and this also serves to hold the first fuse 5 in the first receiving portion 15.

As described above, the first fuse 5 forms part of the fuse puller 30, and is permanently fixed to the permanent engagement portion 35. More specifically, the retaining claws 35c of the permanent engagement portion 35 of the fuse puller 30 are permanently engaged with the engagement portions 24 of the first fuse 5, so that the permanent engagement portion 35 permanently retains the first fuse 5.

Therefore, immediately after a maintenance man or the like of the dealer looks at the fuse mounting surface 3 of the fuse box 2, he can easily find the body 33 (particularly the grip portion 32) of the fuse puller 30 among the plurality of fuses (that is, the fuses 10 and the second fuse 6) with their top surfaces 21 disposed flush with one another. Thus, the body 33 (particularly the grip portion 32) of the fuse puller 30 effectively serves also as an index portion for enabling the first fuse 5 to be easily found.

When the first fuse 5 is to be removed, the maintenance man or the like of the dealer grips the grip portion 32 of the fuse puller 30 with the fingers, and pulls the fuse puller 30 upward away from the fuse mounting surface 3 of the fuse box 2, and pulls the fuse puller 30 out of the fuse box 2 as shown in FIG. 7. Thereafter, the maintenance man or the like of the dealer pulls the second fuse 6 out of the second receiving portion 16, using the general purpose fuse puller 8, and inserts this second fuse 6 into the first receiving portion 15, so that the second fuse 6 is held in the first receiving portion 15. At this time, the maintenance man or the like of the dealer can easily find the position of the second fuse 6 since the second receiving portion 16 is disposed adjacent to the first receiving portion 15 in which the first fuse 5 of the fuse puller 30 is mounted. The removed fuse puller 30 having the first fuse 5 is discarded so that it will not be reused by mistake.

The present invention is not limited to the above embodiment, and suitable modifications, improvements, etc., can be made. Furthermore, the material, shape, dimensions, number, disposition, etc., of each of the constituent elements of the above embodiment are arbitrary and are not limited in so far as the invention can be achieved.

For example, the second fuse 2 or other fuse which is to be once pulled out can be permanently engaged with a permanent engagement portion of a fuse puller as described above for the fuse puller 30. In this case, also, the fuse to be pulled out can be easily found, and can be pulled out of the fuse box.

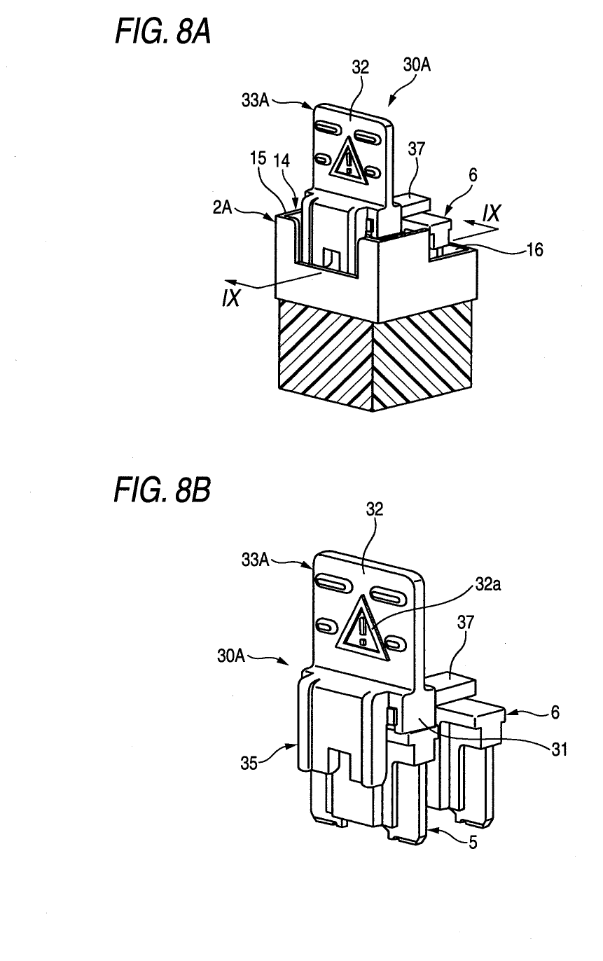

The above embodiment may be modified so that the efficiency of the fuse exchange operation can be further enhanced. In the above fuse exchange method, a considerable force is required for pulling the second fuse 6 (held by the groove-like stepped portion 14a and connection terminals in the second receiving portion 16) from the second receiving portion 16 by the use of the general purpose fuse puller 8. Therefore, a modified fuse puller of the invention (and hence a modified electric junction box) which can improve the efficiency of the operation for pulling the second fuse 6 from the fuse box will be described with reference to FIGS. 8A to 10. Those constituent elements already described above will be designated by identical or like reference numerals, respectively.

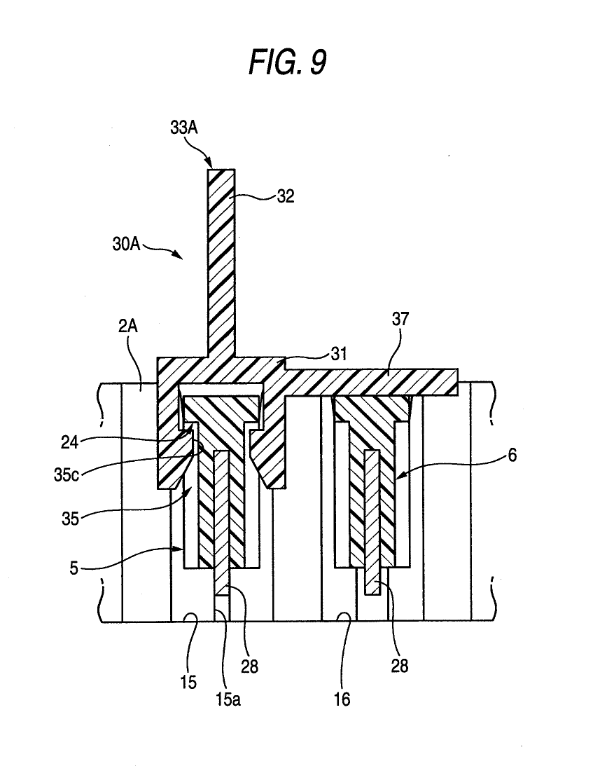

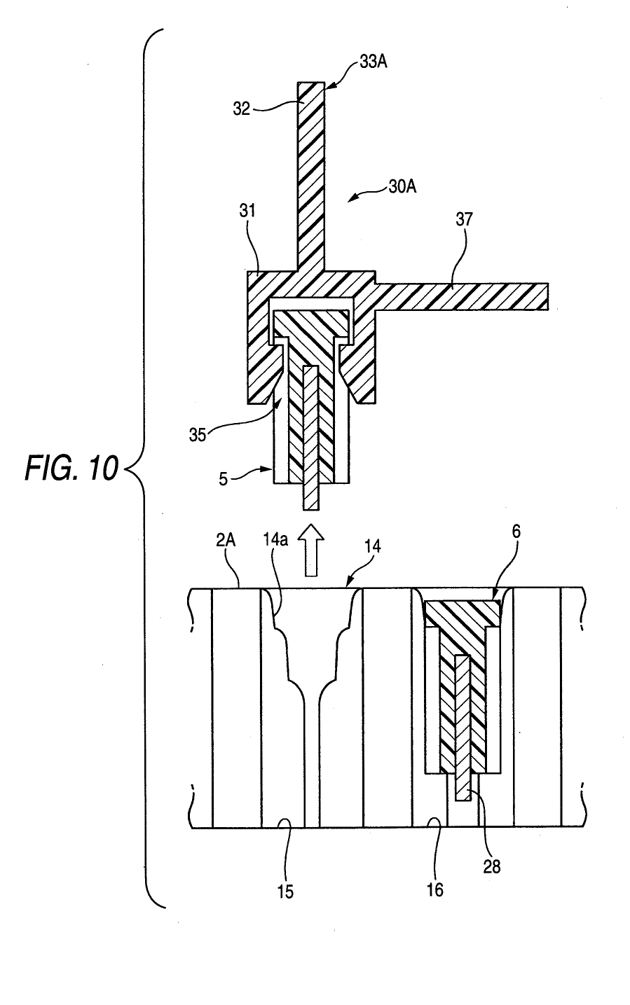

FIG. 8A is a perspective view of an important portion of a fuse box 2A having the modified fuse puller 30A mounted therein, FIG. 8B is a perspective view showing the modified fuse puller 30A and the second fuse 6 held (pressed) by a holding portion 37 of the fuse puller 30A against withdrawal from a second receiving portion 16, FIG. 9 is a cross-sectional view taken along the line IX-IX of FIG. 8A, and FIG. 10 is a view showing a method of pulling the modified fuse puller 30A from the fuse box 2A of FIG. 9.

The fuse puller 30A except the first fuse 5, that is, its body 33A, is made of an insulative synthetic resin, and has a base portion 31 at a generally central portion of the body 33A. A plate-like grip portion 32 is integrally formed (molded) on and projects from a widthwise-central portion of an upper surface of the base portion 31. The grip portion 32 has opposite side faces which are so wide as to be gripped by the fingers, and an index 32a (such as a mark) serving also as a non-slip portion is formed by embossing or engraving on at least one of these opposite side faces. The plate-like holding portion 37 is integrally formed (molded) on and extends laterally from a central portion of a side face of the base portion 31. This holding portion 37 is provided for abutting against a top surface 21 of the second fuse 6 (received in the second receiving portion 16 disposed in the first receiving portion 15) to hold the second fuse 6.

A permanent engagement portion 35 for permanent engagement with the first fuse 5 in fixed relation thereto is formed (molded) integrally on the base portion 31. As shown in FIGS. 9 and 10, the permanent engagement portion 35 includes a pair of side walls 35a and 35b formed respectively at the opposite side edges of the base portion 31, and extend downwardly from a lower surface of the base portion 31. Retaining claws 35c of a rectangular parallelepiped shape are formed on and project from an inner surface of each side wall 35a, 35b. The engagement portions 24 of the first fuse 5 are permanently engaged with the upper sides of the retaining claws 35c, so that the permanent engagement portion 35 and the first fuse 5 are permanently fixed to each other. A lower surface of each retaining claw 35c is tapering so as to guide the engagement portion 24 of the first fuse 5 to the upper side of the retaining claw 35c.

Next, inspection of the on-board equipments, transport of the vehicle, and a method of exchanging the fuse by the use of the fuse puller 30A will be briefly described with reference to FIGS. 1 and 3.

First, in the inspection line at the vehicle production site of the vehicle manufacturer, the on-board equipments 9 are energized via the first fuse 5, and at this time the inspection of the on-board equipments 9 is effected. After this inspection is finished, the coupler 13 is connected to the connector 12, thereby melting the first fuse 5. Whether the inspection of the on-board equipments 9 is effected via the first fuse 5 alone or via the fuse puller 30A incorporating the first fuse 5 is suitably selected. However, it is preferred to permanently engage the first fuse 5 with the body 33A of the fuse puller 30A after the first fuse 5 is melted, in which case advantageously a melted condition of a fusible element 29 of the first fuse 5 can be confirmed with the eyes. In any case, the first fuse 5 is permanently fixed to the permanent engagement portion 35 of the fuse puller 30A before the vehicle subjected to the inspection is delivered (shipped) from the vehicle manufacturer.

Then, the vehicle in this condition is transported from the vehicle manufacturer to a dealer. Therefore, a dark current is prevented from flowing through the on-board equipments 9.

Then, the melted first fuse 5 received in the first receiving portion 15 of the fuse box 2A is exchanged with the second fuse 6 (which is not melted) by the dealer. This fuse exchange method will be described in further detail with reference to FIGS. 9 and 10.

As shown in FIG. 9, the first fuse 5 of the fuse puller 30A is received in the first receiving portion 15 of the fuse box 2A. A groove-like stepped portion 14a (see FIG. 10) for holding a wide portion 22 (see FIG. 2) of a cover member 20 is formed in each of receiving portions 14 except the second receiving portion 16, and thanks to the provision of the groove-like stepped portion 14a, the first fuse 5 is detachably held in the receiving portion 14. Further, the plate-like terminals 28 of the first fuse 5 are gripped respectively by the connection terminals 15a in the first receiving portion 15, and this also serves to hold the first fuse 5 in the first receiving portion 15.

On the other hand, plate-like terminals 28 of the second fuse 6 are not gripped by a groove of the second receiving portion 16, and is not firmly held or retained in the second receiving portion 16, but is loosely fitted in the second receiving portion 16. In this case, the second fuse 6 is pressed downward by the holding portion 37 of the fuse puller 30A, and the cover member 20 of the second fuse 6 is held between the holding portion 37 and a bottom surface disposed at opposite sides of an opening of the groove in the second receiving portion 16 as shown in FIG. 9, and therefore the second fuse 6 is prevented from disengagement from the second receiving portion 16.

The first fuse 5 forms part of the fuse puller 30A, and is permanently fixed to the permanent engagement portion 35. More specifically, the retaining claws 35c of the permanent engagement portion 35 of the fuse puller 30A are permanently engaged with the engagement portions 24 of the first fuse 5, so that the permanent engagement portion 35 permanently retains the first fuse 5.

Therefore, immediately after the maintenance man or the like of the dealer looks at the fuse mounting surface 3 of the fuse box 2A, he can easily find the body 33A (particularly the grip portion 32) of the fuse puller 30A among the plurality of juxtaposed fuses 10 with their top surfaces 21 disposed flush with one another. Thus, the body 33A (particularly the grip portion 32) of the fuse puller 30A effectively serves also as an index portion for enabling the first fuse 5 to be easily found.

When the first fuse 5 is to be removed, the maintenance man or the like of the dealer grips the grip portion 32 of the fuse puller 30A with the fingers, and pulls the fuse puller 30A upward away from the fuse mounting surface 3 of the fuse box 2A, and pulls the fuse puller 30A out of the fuse box 2A as shown in FIG. 10, and at this time the holding of the second fuse 6 in the second receiving portion 16 by the holding portion 37 is canceled. Thereafter, the maintenance man or the like of the dealer pulls the second fuse 6 out of the second receiving portion 16, using the general purpose fuse puller 8. At this time, the maintenance man or the like of the dealer can easily take the second fuse 6 out of the second receiving portion 16 without using a large force, since the second fuse 6 is loosely fitted in the second receiving portion 16. Then, the maintenance man or the like of the dealer inserts the second fuse 6 (gripped by the general purpose fuse puller 8) into the first receiving portion 15, so that the second fuse 6 is held in this first receiving portion 15. At this time, the maintenance man or the like of the dealer can easily find the position of the second fuse 6 since the second receiving portion 16 is disposed adjacent to the first receiving portion 15 in which the first fuse 5 of the fuse puller 30A is mounted. The removed fuse puller 30A having the first fuse 5 is discarded so that it will not be reused by mistake.

In the electric junction box (i.e., the fuse box 2) of the above embodiment and the modified electric junction box (i.e., the fuse box 2A), the fuse (i.e., the first fuse 5, the second fuse 6, etc.) to be removed is permanently engaged with the body 33 (33A) of the fuse puller 30 (30A) in fixed relation thereto. However, when attention need to be directed only to the index portion for enabling the relevant fuse to be easily found at the fuse mounting surface 3 at which the plurality of fuses are arranged in a juxtaposed manner, the fuse does not always need to be permanently engaged with the fuse puller body in fixed relation thereto.

Although the above embodiment of the present invention is directed to the fuse box (electric junction box), the invention can be applied to any other suitable electric junction box and the like such as a power box, a relay box, an electronic control unit box, etc., in so far as a plurality of fuses are detachably received in a plurality of receiving portions in a juxtaposed manner.

The illustrated shape of the fuses used in the above embodiment is one example, and any other suitable fuses can be used in the invention. Furthermore, the illustrated shape of the fuse receiving portions of the fuse box in the above embodiment is one example, and the fuse receiving portions can have any other suitable shape. The fuse pullers of the invention are not limited to the illustrated shapes, and can have any other suitable shape without departing from the subject manner of the invention.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2007-256663 filed on Sep. 28, 2007, the contents of which are incorporated herein for reference.

What is claimed is:

1. A fuse puller comprising:
a body; and
a first fuse that is permanently engaged with the body in fixed relation thereto.

2. The fuse puller according to claim 1, wherein the first fuse has a fusible element which is melted.

3. The fuse puller according to claim 1, wherein the body includes:
a permanent engagement portion which is permanently engaged with the first fuse; and
a holding portion which holds a second fuse against an electric junction box; and
wherein the second fuse is received in the electric junction box in adjoining relation to the first fuse received in the electric junction box.

4. A electric junction box comprising:
a fuse puller that includes a body and a first fuse which is engaged with the body; and
a fuse mounting surface to which a plurality of fuses including the first fuse are mounted so as to be arranged in parallel to each other.

5. The electric junction box according to claim 4, wherein the first fuse is permanently engaged with the body in fixed relation thereto.

6. The electric junction box according to claim 4, wherein the first fuse has a fusible element which is melted.

7. The electric junction box according to claim 4, wherein the body includes:
an engagement portion which is engaged with the first fuse; and
a holding portion which holds a second fuse loosely fitted in a second receiving portion disposed adjacent to the first fuse held in a first receiving portion of the fuse mounting surface.

8. The electric junction box according to claim 4, wherein the plurality of fuses including the first fuse have the same outer shape.
